(19) United States
(12) Patent Application Publication
(10) Pub. No.: US 2016/0180469 A1
(43) Pub. Date: Jun. 23, 2016

(54) WORKFLOW MANAGEMENT SYSTEM

(71) Applicant: WholeSource, LLC, Phoenix, AZ (US)

(72) Inventors: James Keating, Phoenix, AZ (US); Mark Meury, Phoenix, AZ (US); Donald Fleming, Phoenix, AZ (US)

(21) Appl. No.: 14/970,860

(22) Filed: Dec. 16, 2015

Related U.S. Application Data
(60) Provisional application No. 62/095,424, filed on Dec. 22, 2014.

(51) Int. Cl. G06Q 40/08; H04L 12/58; H04L 29/08

(52) U.S. Cl. CPC G06Q 40/08; H04L 67/10; H04L 51/04

(57) ABSTRACT

The present invention relates to a workflow management system that manages all aspects of a customer account, including account initiation, management and electronic document storage through one simple and clean user interface running on a server via a terminal. The system includes a server and a user terminal in network communication with the server, wherein the user terminal is a dummy terminal. The system further includes a software application installed on and operated by the server. The system comprises a unique folder structure for each account created by the system in response to execution of the instructions of the software application by the server, wherein the unique folder structure is created within an electronic document library stored on the hard drive of the server. The system further includes an automatic email save function, wherein emails are automatically saved in a folder of the folder structure of the electronic document library.

### CROSS REFERENCE TO RELATED APPLICATION[S]

This application claims priority to U.S. Provisional patent application entitled “WORKFLOW MANAGEMENT SYSTEM,” Ser. No. 62/095,424, filed Dec. 22, 2014, the disclosure of which is hereby incorporated entirely herein by reference.

### BACKGROUND OF THE INVENTION

1. Technical Field

This invention relates generally to management systems and more particularly to a workflow management system that manages all business production, account management, and electronic document storage through a simple, unified user interface.

2. State of the Art

The management of certain service accounts (such as, for example, accounts involving the purchase and ownership of various types of insurance) currently involves the use of various multiple, distinct software applications. When managing accounts, a user must typically access a plurality of these various software applications. These software applications do not communicate with each other and do not provide for a centralized remote access to an account management system utilizing the multiple, distinct software applications. Rather, to manage an account, a user must access several of the multiple, distinct applications separately on a user computer and manually going through several steps to utilize the various multiple, distinct applications to manage and properly document an account from creation (beginning the policy opening process) through binding (completion of the policy opening process). What is lacking is a system that can easily and efficiently accomplish all aspects of account processing and management.

Accordingly, there is a need in the field of account management systems for an improved management system that allows for complete workflow management and electronic document storage without the need to access multiple, distinct software programs separately from multiple user interfaces.

### DISCLOSURE OF THE INVENTION

The present invention relates to a workflow management system that manages all aspects of a customer account, including account initiation, management and electronic document storage through one simple and clean user interface. The user interface walks the end user through the account setup (binding, in the case of insurance policies) process from initiation of a new account to invoicing of a completed/existing account. The system is accessed through a remote desktop management session. All virtual desktops reside in two main collocations.

An embodiment comprises a workflow management system comprising a server and a user terminal in communication with the server, wherein the user terminal is a dummy terminal that connects to the server and the server performs all operations and send minimal information to the display of the user terminal in response to execution of code in the server. The system further comprises a software application residing on the server, wherein the software application responds to user input received from the user terminal. In particular embodiments, the system comprises a unique electronic folder structure located on the server for each account created by the system in response to execution of the instructions of the software application, wherein the unique folder structure is created within an electronic document library stored on one of a hard drive of the server or a remote data storage. The system further comprises an automatic save function, wherein emails related to a specific account sent through the system are automatically saved in a folder of the folder structure for that specific account in the electronic document library.

Another embodiment of the present invention includes a workflow management system comprising: a server having a processor, memory, and a hard drive; a user terminal in network communication with the server, wherein the user terminal is a dummy terminal having a processor, memory, a hard disk, a video card, a display, and input/output devices; and a software application installed on and operated by the server, wherein the server executing the software application automatically directs a user communicating with the server with the user terminal through an insurance account binding process from clearance to invoicing, wherein: the system comprises a unique folder structure for each account created by the server in response to the server executing instructions of code of the software application to automatically create the unique folder structure within an electronic library stored on one of the hard drive of the server or a remote data storage, wherein each folder structure is associated with a particular account, and the folder structure includes automatic naming of folders and subfolders within the folder structure.

Another embodiment includes a workflow management system comprising: a computing device having a processor, memory, and a hard drive; and a software application installed on and operated by the computing device, wherein the computing device executing the software application automatically directs a user through an insurance account binding process from clearance to invoicing, wherein: the system comprises a unique folder structure for each account created by the computing device in response to the computing device executing instructions of code of the software application to automatically create the unique folder structure within an electronic library stored on the hard drive of the computing device or on a remote data storage, wherein each folder structure is associated with a particular account, and the folder structure includes automatic naming of folders and subfolders within the folder structure.

Another embodiment includes a method of processing and managing an account during the life-cycle of the account, the method comprising: providing a software application stored and operated on a computing device, wherein the software application provides an account workflow, wherein the software application provides a user interface for each required step to process an account, the steps comprising a specific sequence of steps of clearance, followed by submit to market, followed by quote to agent, followed by bind and invoice, followed by endorsements, followed by accounting, and followed by claims; controlling a user's access to the required steps to process the account with the software application, wherein the software application controls the user's access by restricting access to and data entry through the user interface associated with a particular step until a previous step is completed; and automatically creating a unique folder structure for an account in response to the computing device executing instructions of code of the software application to automatically create the unique folder structure within an electronic library stored on a hard drive of the computing device or on a remote data storage, wherein each folder structure is associated with the account, and the folder structure includes automatic naming of folders and subfolders within the folder structure.

The foregoing and other features and advantages of the present invention will be apparent from the following more detailed description of particular embodiments of the invention, as illustrated in the accompanying drawings.

### BRIEF DESCRIPTION OF THE DRAWINGS

Some of the embodiments will be described in detail, with reference to the following figures, wherein like designations denote like members:

FIG. 1 is a view of a dashboard screen;

FIGS. 2A-2C are views of various navigation screens;

FIG. 3 is a view of a clearance screen;

FIG. 4 is a view of a clearance screen with a decline account option;

FIG. 5 is a view of an account search screen;

FIG. 6 is a view of a clearance screen;

FIG. 7 is a view of a submission screen after a user has dragged a submission into the system screen.

FIG. 8 is a view of a cover letter screen form;

FIG. 9 is a view of a screen for the user to choose which markets and underwriters to send the submission;

FIG. 10 is a view of a screen summarizing the submitted submission;

FIG. 11 is a view of a quote screen;

FIG. 12 is a view of a quote entry form screen;

FIG. 13 is a view of a quote summary screen;

FIG. 14 is a view of a bind and invoice screen;

FIG. 15 is a view of a bind and invoice screen after a user drags in a binder from the carrier;

FIGS. 16A-16B are a views of a bind and invoice entry form;

FIG. 17 is a view of binder summary screen;

FIG. 18 is a view of policy screen;

FIGS. 19A-19B are views of a policy data entry form;

FIG. 20 is a view of an endorsement screen;

FIG. 21 is a view of save agent endorsement request screen generated when dragging in an endorsement request into the endorsement screen of FIG. 20;

FIG. 22 is a view of a send endorsement screen;

FIG. 23 is a view of a save carrier endorsement screen;

FIG. 24 is a view of a send carrier endorsement screen; and

FIG. 25 is a view of an accounting screen.

FIG. 26 is a view of a production dashboard screen.

FIGS. 27A-27B are views of a producer dashboard screen.

FIGS. 28A-28B are views of a team leader dashboard screen.

FIGS. 29A-29B are views of an executive dashboard screen.

FIG. 30 is a view of a workers compensation submission screen with detail on marketing an account.

FIG. 31 is a view of a workers compensation loss information screen.

FIG. 32 is a view of a workers compensation underwriting information screen.

FIG. 33 is a view of a rate screen for use with small business underwriting.

FIG. 34 is a view of a save agent/create submission screen.

FIG. 35 is a view of a submitted summary screen.

FIG. 36 is a view of a claims screen.

FIG. 37 is a view of a claim request screen.

FIG. 38 is a view of a send claim screen.

FIG. 39 is a view of an assignment screen.

FIG. 40 is a view of a marketing calendar screen.

FIG. 41 is a view of add marketing appointment screen.

### DETAILED DESCRIPTION OF EMBODIMENTS OF THE INVENTION

As discussed above, embodiments of the present invention relate to a workflow management system that manages all aspects of a customer account (including, for example, new account setup and maintenance, electronic account document storage, and invoicing) through one simple and clean user interface. For new accounts, the user interface walks the user through the account binding process from initial information gathering (clearance, in the case of an insurance policy) to invoicing. For existing accounts, the user interface walks the user through all account management functions. The system is accessed through a remote desktop management session.

Various components are required for the workflow management system to operate. The workflow management system includes a server having a processor, memory, a hard drive, and a network card. The system also includes a user terminal, wherein the user terminal is a dummy terminal. As will be understood in this disclosure, a dummy terminal includes a computing device having a processor, memory, a hard disk, a video card, a display, a network card, and input/output devices, such as but not limited to, a keyboard, a mouse and the like. The dummy terminal does not store any critical data; rather it is used to access the server through a user portal. The server operates to perform all of the operations of the workflow management system, stores all of the data associated with various accounts, performs complex operations related to the various accounts, and executes software and operating systems of the workflow management system. The user terminal operates to display workflow management system information and account information on the display of the user terminal, and to provide information to the server for processing. The processor and memory of the user terminal operate to process the information necessary to provide the user interface to the display, to for access the information on the server, and perform other tasks of the workflow management system. The input/output devices operate to allow user input to the user terminal, and to allow output of the workflow management system to be provided to the user via the user terminal. User input provided to the user terminal is sent through a network connection between the user terminal and the server to the server for processing of that user input data by the server. The user interface is configured to display data and programs running on the server.

Employing a user terminal that is a dummy terminal provides an extra layer of security for the workflow management system. Because the user terminal only accesses account information stored and maintained on the server (rather than locally on the user terminal), if the user terminal is damaged, stolen or otherwise compromised, the account information is not at risk because the information is not stored locally on the user terminal.

In operation, the user terminal provides for a user interface having various components that allow the input of information to the server, and display server information on the user terminal. The input and information is communicated to and from the server through a network connection between the server and the user terminal. This user interface is separated into various sections and/or screens that may be displayed individually or simultaneously in sections of the display of the user terminal. The various sections and/or screens may include, without limitation, dashboards, navigation screens, clearance screens, and other screens. Although specific reference is may be made throughout this application to terms related to the insurance industry, it should be appreciated that the workflow management system may be utilized in a variety of fields and applications other than insurance.

1. Dashboard

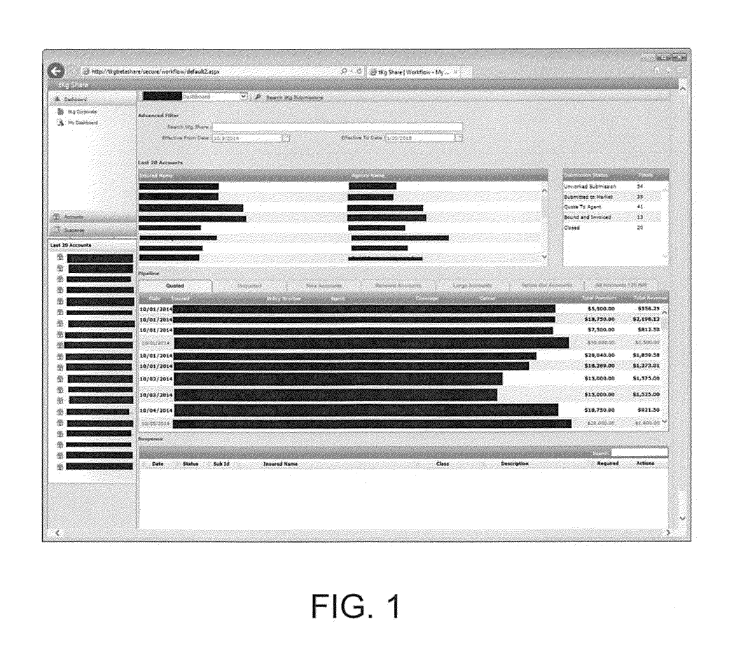

The producer dashboard, as shown in FIG. 1 provides a user (producer, also known as an insurance agent in the case of an insurance application) and his associates (other members of the company working for or with an assigned user) the ability to manage client accounts (such as, in the case of insurance, a book of business). When a user access the workflow management system, the user view will default to the user (producer, in the case of insurance), or in the case of an associate of the user (producer), the user (producer) to which they are assigned. At the producer dashboard, a user can change producers or search for an account. The dashboard is displayed on the user terminal display in response to execution of software instructions on the server. The dashboard may be accessed at the user terminal by logging into the system through a web portal or the like. Once logged in, the display will display graphical information being processed by the server and sent to the display of the user terminal.

2. Navigation

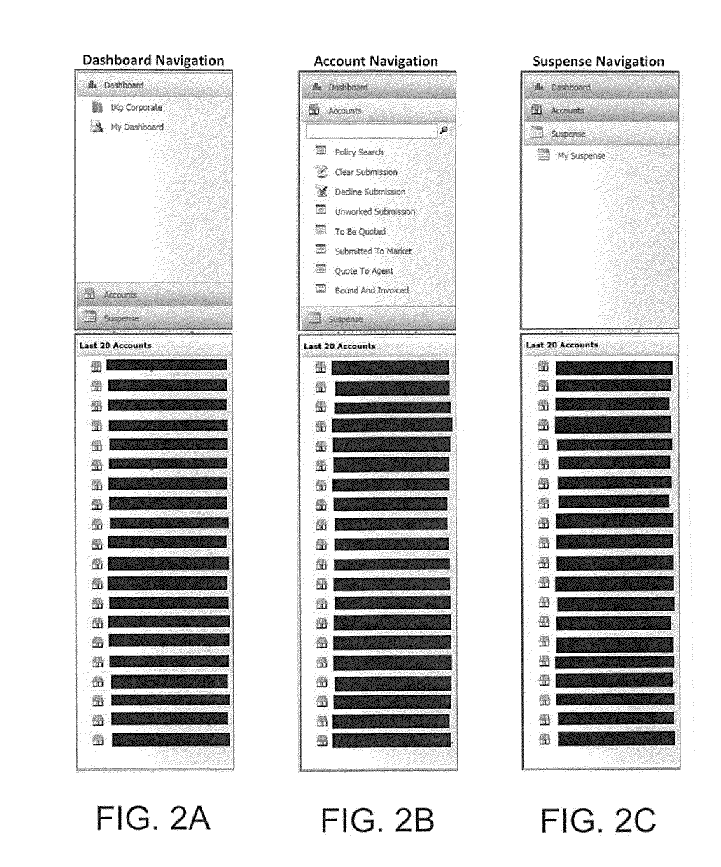

Every page displayed to a user of the workflow management system on the user terminal has an identically formatted navigation panel on the left-hand side of the display of the user terminal such that the functions of the navigation panel may be accessed at any time via any displayed page of the workflow management system. The navigation panel is located on the left of the display and is fixed (in terms of location, format and functions available) for all pages or screens of the workflow management system. The navigation panel allows the user to navigate quickly and easily to and through various accounts, or to search for an account. Examples of the navigation panel are generally illustrated in FIGS. 2A-2C, in which FIG. 2A generally illustrates the navigation panel when “Dashboard” is selected by the user, FIG. 2B generally illustrates the navigation panel when “Accounts” is selected by the user, and FIG. 2C generally illustrates the navigation panel when “Suspense” is selected by the user.

3. Clearance

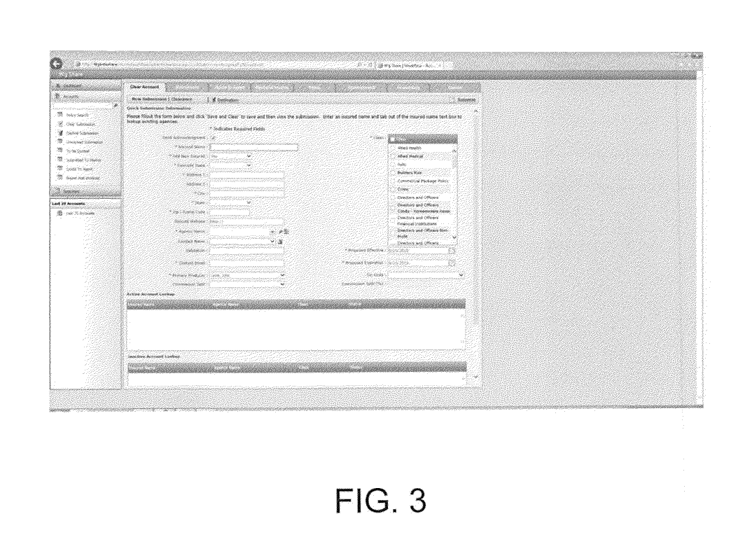

The clearance screen, shown in FIG. 3, allows a user to enter a new account in the workflow management system. In the present embodiment, a new account is a submission from an agency for an insured looking for a specific type of insurance coverage. When a user enters an insured name, the workflow management system will automatically search for all similar named insureds in the system as stored in the hard drive of the server. This will allow the user, if the insured already exists in the workflow management system, to avoid entering redundant information already in the system. Once the new account is created (either by entering the new insured information, or using already stored information), a unique folder structure is automatically created in the electronic document library. The folder structure is associated with that particular insured's account, and allows easy look-up in the future of the insured's information in the database of the hard drive of the server. In embodiments, the folder structure of the library may be maintained on a remote data storage, such as a cloud service, digital media and the like. The server or computing device operating the software application may be in communication with the remote data storage in order to obtain and process the information. The folder structure allows for easy and proper storing and organization of the account documents, communications (such as, for example, emails) and the like associated with that particular insured's account. Once an account is created, an automated email is generated to the insurance agency for that particular policy and account, and the email is saved in the electronic document library for the insured's account.

According to embodiments of the present invention, the unique folder structure created by the system in the electronic document library for a particular insured's account may represent the life cycle of the account. The naming convention and organization of the folders may be standardized. Each main folder may correspond to the specific application section the user is working on in the system. The sub folders within the application folders may represent and correspond with the steps and contains all the necessary correspondence and files associated with that particular section/phase of the life cycle of the account. The system may start with “000 Correspondence” and work its way up to “600 Accounting.” Application level folders are all incremented by 100. Sub Folders start with 01 and will work up 02, 03, etc. The following is an example of a folder tree structure according to embodiments of the workflow management system:
000 Correspondence
100 Clear Account
   01 Retailer Submission
   02 Acord
   03 Supplemental
   04 Loss Runs
   05 Financials
   06 Other
200 Submission to Market
   01 Submission
300 Quote to Agent
   [PayToCompanyId]—a list of all companies to whom quotes are sent or from whom quotes are received
400 Bind and Invoice
   01 Bind Request from Agent
      01 TRIA
      02 Affidavit
      03 Subjectivities
   02 Bind Request to Carrier
   03 Carrier Binder
   04 Binder and Invoice
500 Policy
   01 Policy
   02 Endorsement
   03 Cancellation
   04 claims
600 Accounting

4. Decline an Account

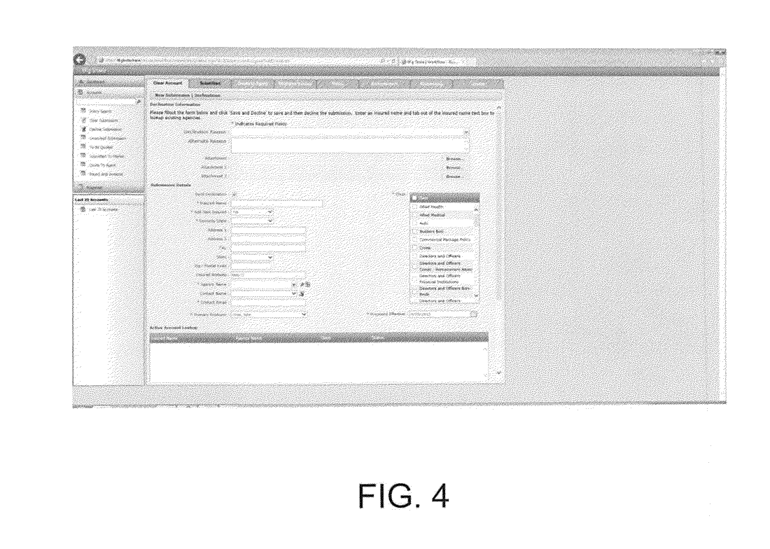

The decline screen shown in FIG. 4 under the “Clear Account” tab allows a user to decline an account in the system. The user can also flag (“Yellow Dot”) the account, such that the system will automatically notify the user to review the account 120 days prior to it renewing in case the user wants to market to the client the following year. A unique folder structure is automatically created in the electronic document Library capturing the information associated with the declining of an account. An automated email is generated to the agency and saved in the electronic document library for the account.

5. Account Search

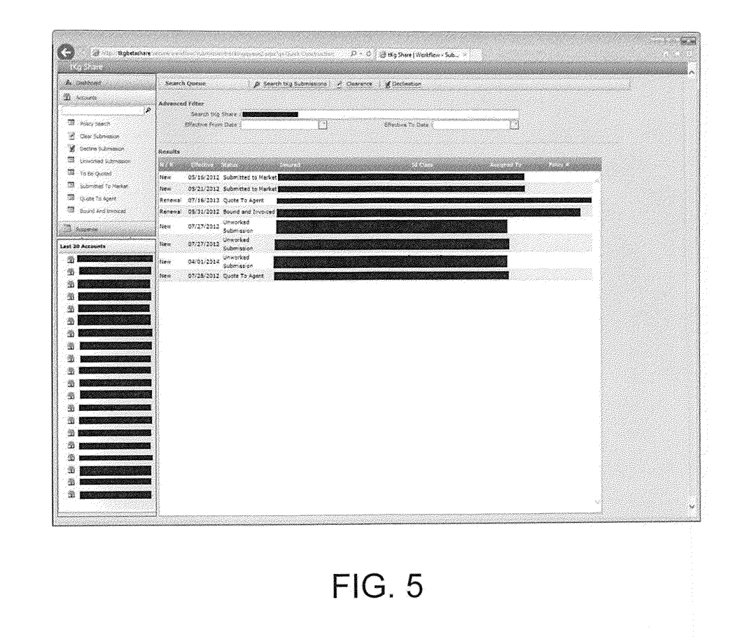

The user can search for a specific insured in the workflow management system using the account search screen shown in FIG. 5. The workflow management system may use fuzzy logic to look up and list relevant accounts specific to the search term entered. Those of ordinary skill in the art will understand that while fuzzy logic may be used for search purposes, other types of search strategies and algorithms may be employed by the workflow management system, such as Boolean searching and the like. Clicking on an account will navigate the user to an account workflow screen, and take them to the step where the account has been left in the life cycle of the account.

6. Account Workflow

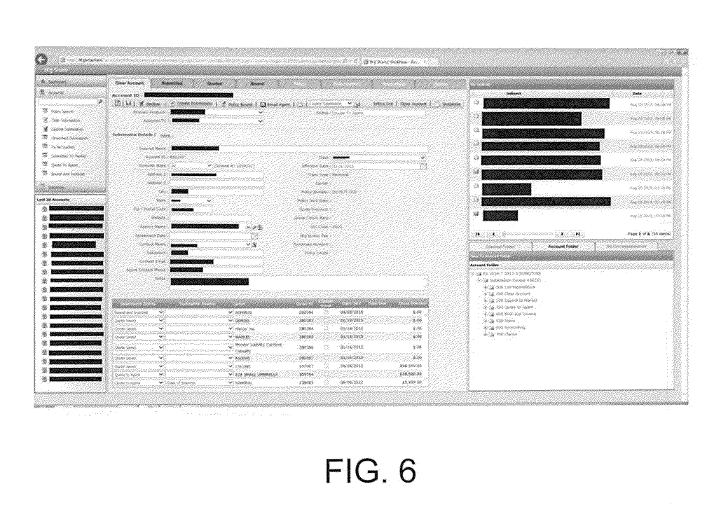

The account workflow is a screen showing and allowing access to the various applications used or required to process and manage an account during the life-cycle of an account and/or policy. In the present embodiment, the applications (shown as tabs in FIG. 6) include: Clearance (“Clear Account”), Submit To Market (“Submitted”), Quote To Agent (“Quoted”), Bind (“Bound”) and Invoice (“Policy”), Endorsements (“Endorsement”), Accounting (“Accounting”), and Claims (“Claims”). This application can be tailored specifically to various profit centers and/or divisions of the business utilizing the workflow management system. Each application section has task tabs to walk the user through the tasks associated with each application. If a task is not completed in the sequence of applications (left-to-right), the user cannot proceed to the next task. In addition the last application tab is always a summary tab to allow the user to not have to navigate back to previous tabs to retrieve information. As a user completes the application sections, the tabs associated with those completed application sections will show the text in black. All white text in a tab indicates an application task which has not been completed.

a. Clearance

The clearance screen is a basic screen to show the details of the account. This is shown in FIG. 6.

b. Submit to Market

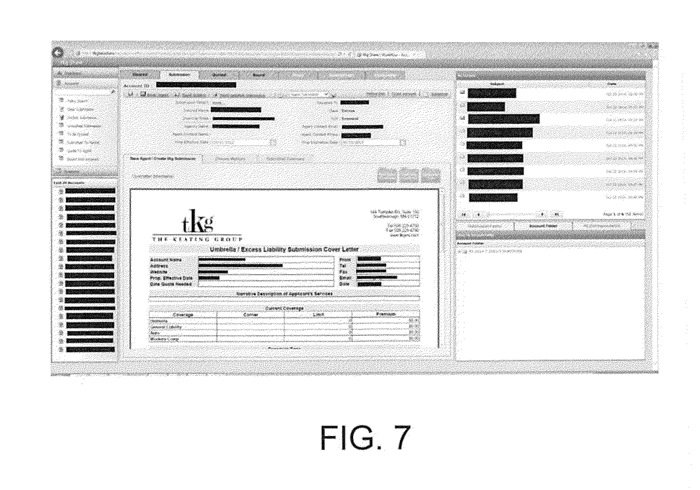

In the present embodiment, and as is generally illustrated in FIG. 7, a user may drag a submission into the workflow management system screen from an email or other portion of the workflow management system, and only from within the workflow management system screen on the display of the user terminal. Once the submission is dragged and dropped in the workflow management system screen, the system will automatically save the original email and attachments in a designated folder of the folder structure of the electronic document library associated with the relevant account. In addition it will make a copy of the dragged document for the user to redact.

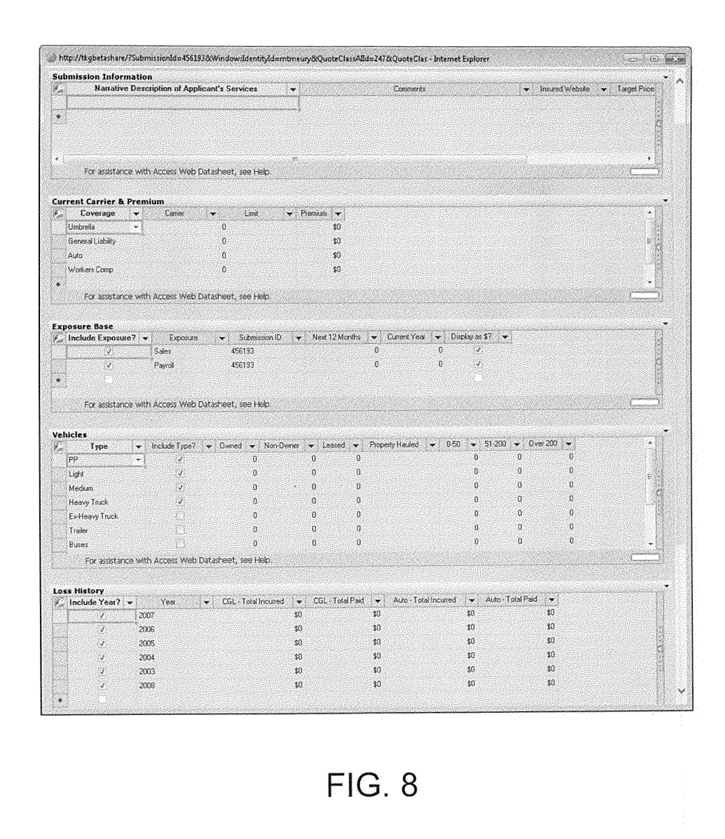

Clicking on the create submission folder of FIG. 7 causes the workflow management system to display the submission for the user to redact, and causes a cover letter entry form having all required field for the defined class of business to be generated. The workflow management system will open the submission on the left side of the screen in a PDF viewer, and will open the cover letter entry form on the right side of the screen. A cover letter entry form is generally illustrated in FIG. 8.

A preview of the cover letter can be seen when the user clicks on the first tab on the left of the “Submission” screen (the “Save Agent/Create Submission” tab).

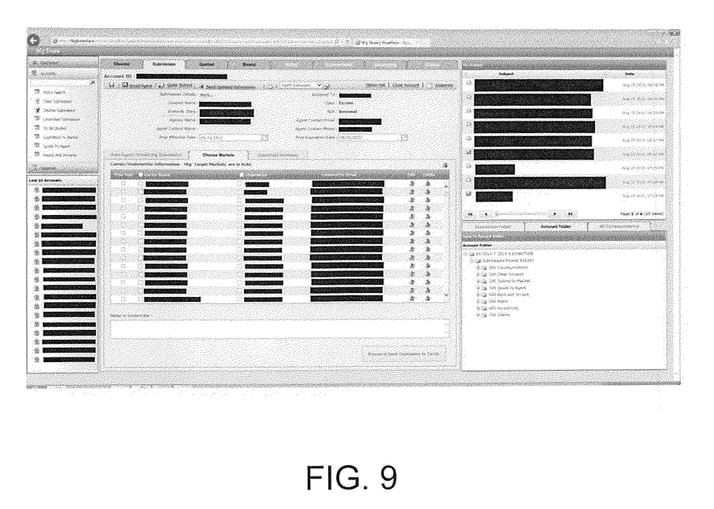

As is generally illustrated in FIG. 9, showing what is displayed when the “Choose Markets” tab is selected by a user, a user can choose which market(s) and underwriters to email the submission to via the system's automated email system. If a submission has not been added to the system already, the “Preview & Send Submission to Carrier” button (located in the lower right-hand corner of the screen) will not appear. If the button does appear, clicking this button will display a form, which will allow the user to select uploaded attachments and preview and send the submission. All correspondence generated is saved in their respected carrier folder in the electronic document library.

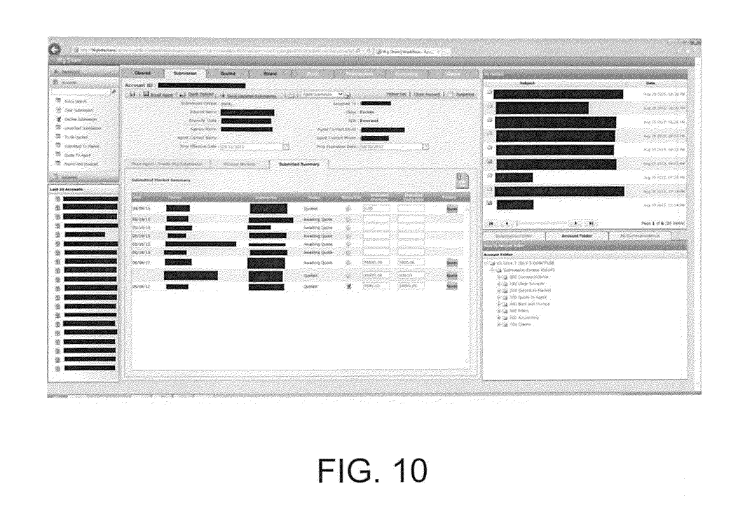

FIG. 10 generally illustrates the “Submitted Summary” page of the “Submission Screen.” This screen allows a user to preview a list of carriers to whom submissions have been provided. In addition, this screen provides the opportunity for users to add indicated premium and deductibles to the record. Finally, if a quote has already been saved, a quote folder will display. Clicking on the folder will open the saved quote.

c. Workers Compensation Submission Page

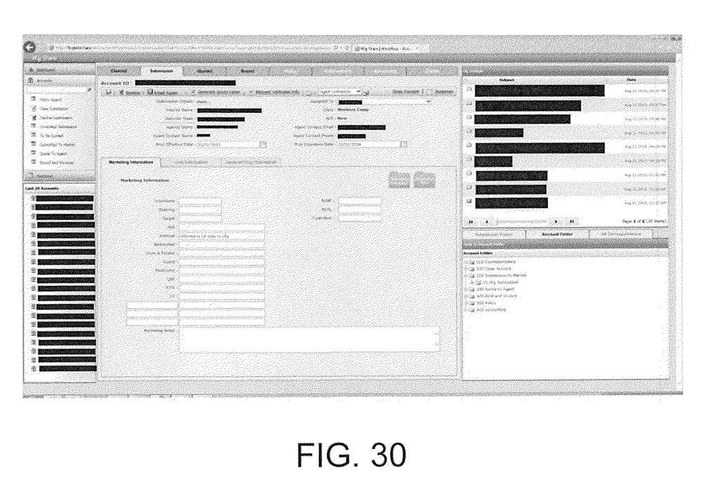

The submission screen is a basic screen to show the details on marketing an account. As shown in FIG. 30, a user drags a submission into the system. Once the submission is in the system, the system will save the original email and attachments, and additionally will make a copy of the document for the end-user to redact the “Marketing Information.”

Clicking on the create submission folder operates to have the system display the submission for a user to redact and a cover letter entry form of all required field for the defined class of business. The system opens the submission in PDF editing software and the cover letter form, similar to that shown in FIG. 7.

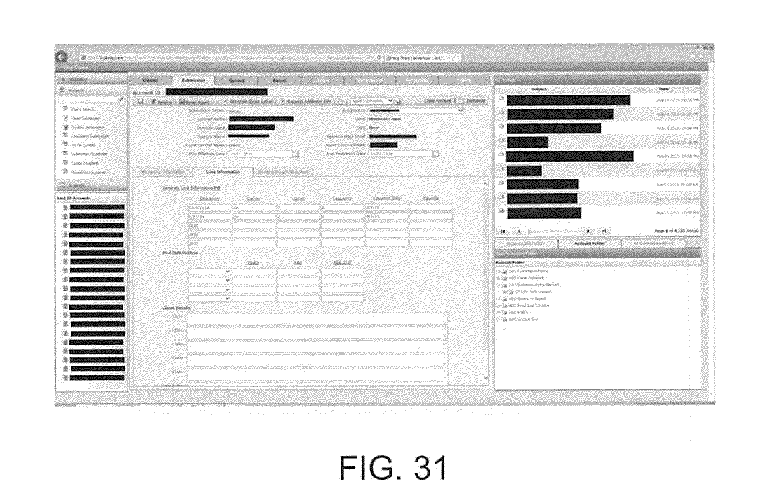

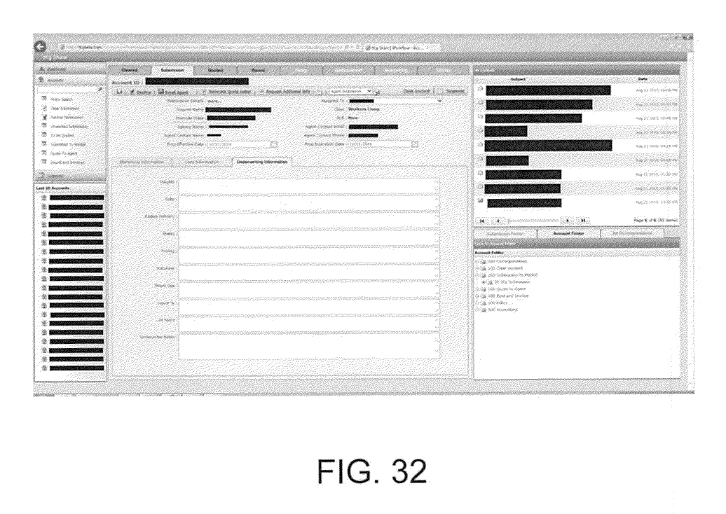

Referring to FIG. 31, user can enter loss information history and claim information for a specific submission. Clicking on “Generate Loss Information Pdf” will generate a formatted pdf report on the loss history. Further, as shown in FIG. 32, a user can enter underwriting information.

d. Small Business Underwriting Page

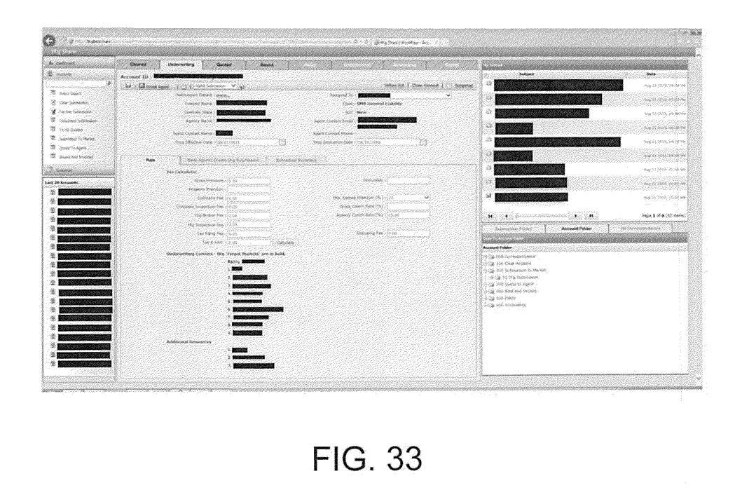

The submission screen is a basic screen to show the details on marketing an account. As seen in FIG. 33, a user can generate taxes on an account and use rating tools to underwrite an account if we're the binding authority.

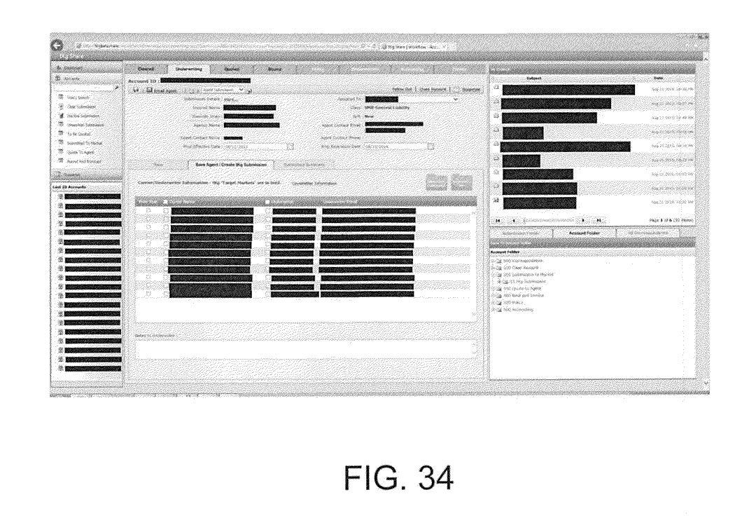

Referring to FIG. 34, a user can perform two functions. First, the user can upload a submission and supplemental files and second, the user can choose which market(s) and underwriters to email the submission to using our automated email system. If a submission is not added to the system the “Preview & Send Submission to Carrier” button will not appear. Clicking this button will display a form, which will allow the user to select uploaded attachments and preview and send the submission. All correspondence will be saved in their respected carrier folder in the electronic document library.

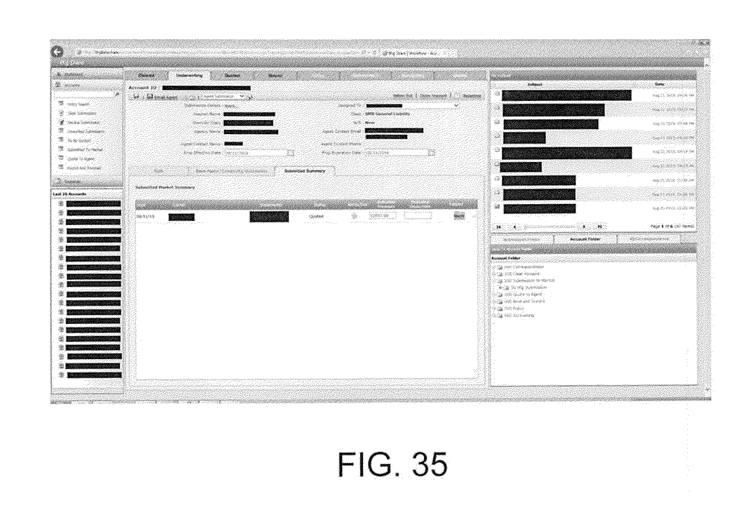

A user can preview a list of carriers they've submitted the submission in a Submitted Summary screen shown in FIG. 35. In addition this screen allows a user to add indicated premium and deductibles. If a quote has been saved, a quote folder will be displayed. Clicking on the folder will open the saved quote.

e. Quote to Agent

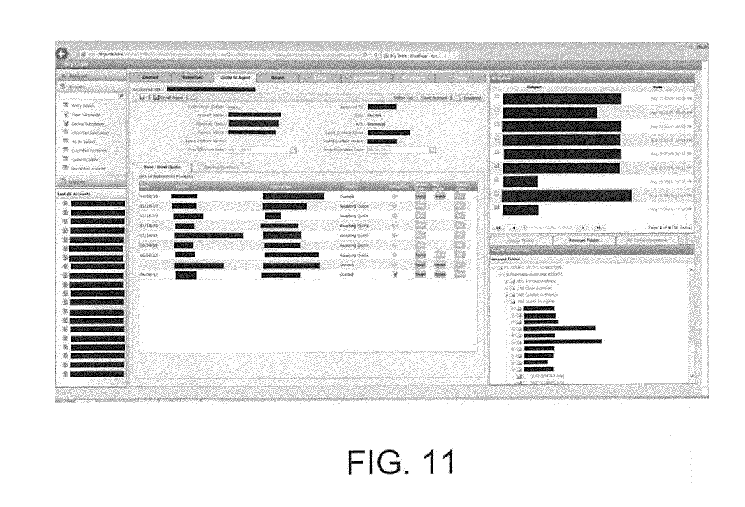

The “Quote to Agent” screen, generally illustrated in FIG. 11, is a basic screen to show a list of all carriers and underwriters to whom the submission was sent. The list has a “Save” folder to allow the user to drag an email out of the outlook component and into the drop zone of the screen. This will allow the user to categorize and save all correspondence and attachments into the electronic document system specific to each carrier. It will also create a duplicate for the broker to redact and send to the agent.

If a quote has already been save for a specific carrier the folder will turn black next to the carrier in the list, and a “Create Folder” icon will appear under the Quote column. Once the user sends out a quote, if there is a new additional quote added to the system, an “Update” folder will appear under the quote column.

In addition the user can make notes or decline a quote by clicking on the note pad icon. All declined quotes will be displayed on the screen including a red “X” icon.

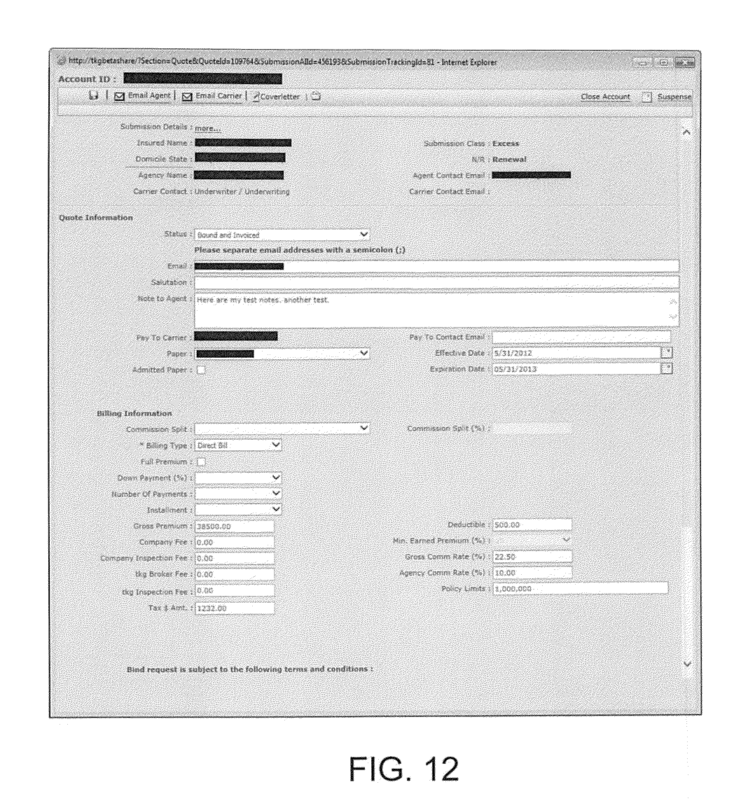

Clicking on the “Create” or “Update” folder from the “Quote to Agent” screen will open up the quote on the left side of the screen, and a data entry form on the right side of the screen, where the quote details can be entered. This is generally illustrated in FIG. 12.

Clicking the “Preview and Send” Quote will allow the user to select uploaded documents and send the quote to the agent along with a template email. The email is uploaded to the electronic document library.

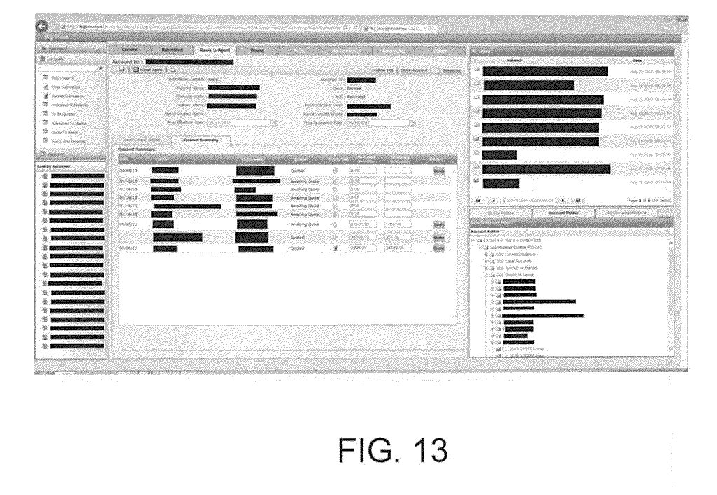

As is generally illustrated in FIG. 13, a user can view the summary of all the quotes received by clicking on the “Quoted Summary” tab of the “Quote to Agent” screen, allowing the user to view this information without the need to navigate back to the previous application section.

f. Bind and Invoice

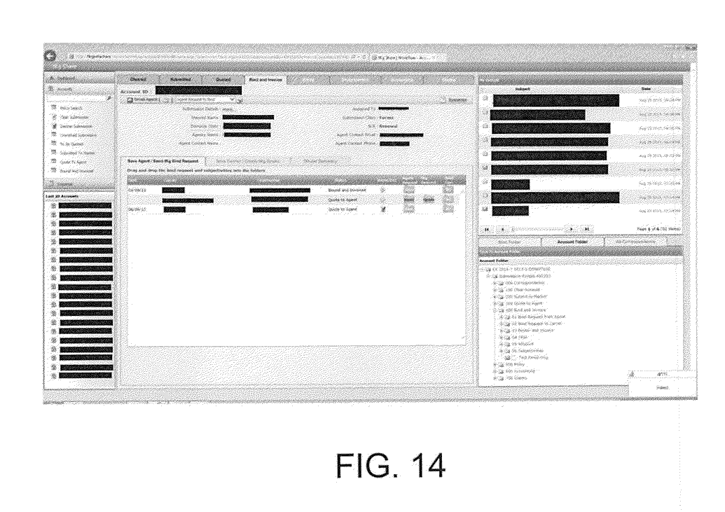

The “Bind and Invoice” screen, generally illustrated in FIG. 14, is a basic screen to show a list of all carriers and underwriters for whom a quote was uploaded and sent to the agent. The list has a “Save” folder to allow the user to drag an email out of the outlook component and into a drop zone. This will allow the user to categorize and save all correspondence and attachments in to the electronic document system specific to each carrier for the request to bind.

FIG. 14 generally illustrates the ability of a user to drag in a “Request to Bind” from an agent, in which case the correspondence will be saved and filed in the electronic document library. Doing so will allow the user to send a template bind request email to the carrier or underwriter and start packaging the binder for the specific account. This email is saved in the file. Once this has been sent, the user is then able to save a carrier binder in the system.

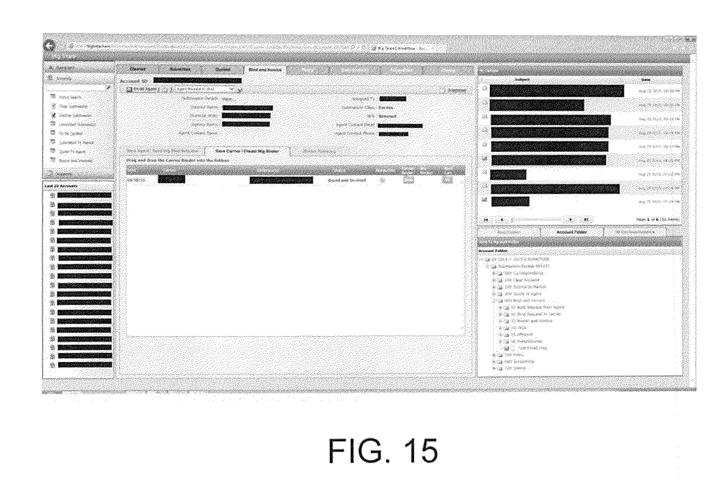

As shown in FIG. 15, generally illustrating a “Save Carrier/Create Binder” tab, this screen, allows a user can to drag in a binder from a carrier. Doing so causes correspondence associated with the binder, and the binder itself, to be saved and filed in the electronic document library. A duplicate binder will be created for the broker to redact and send to the agent, along with an invoice for the account. The user can then send a template binder email to the agent with the attached invoice. This email is saved in the electronic document library.

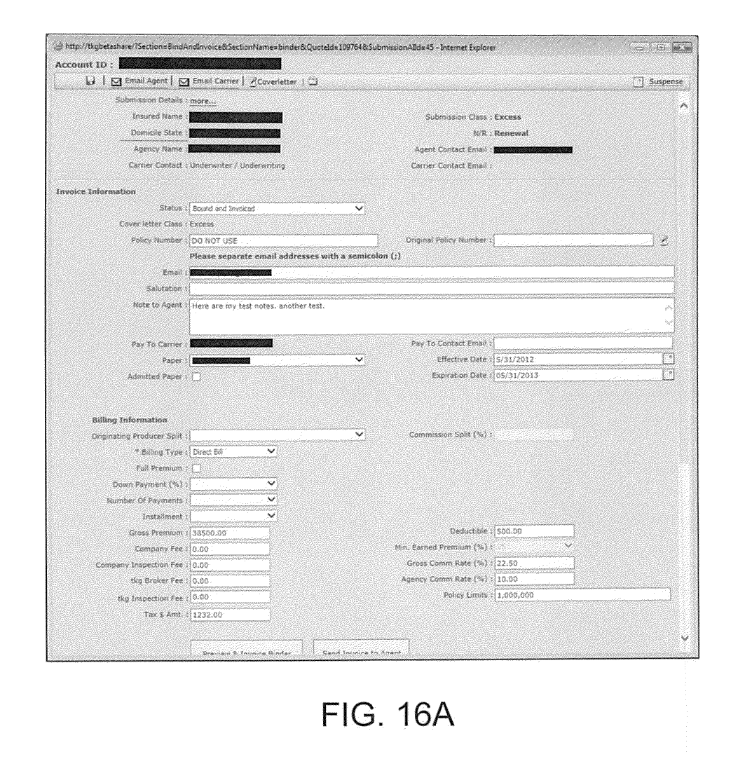

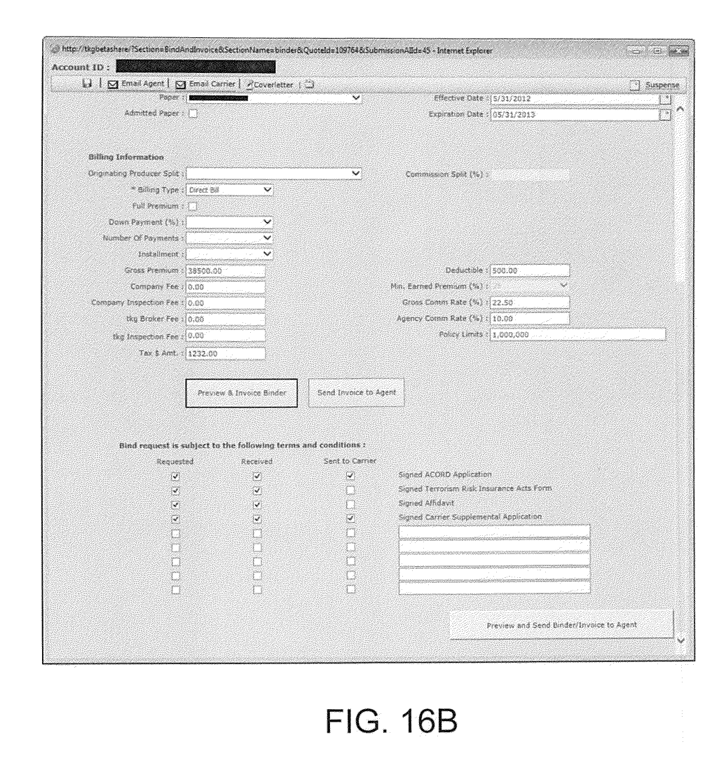

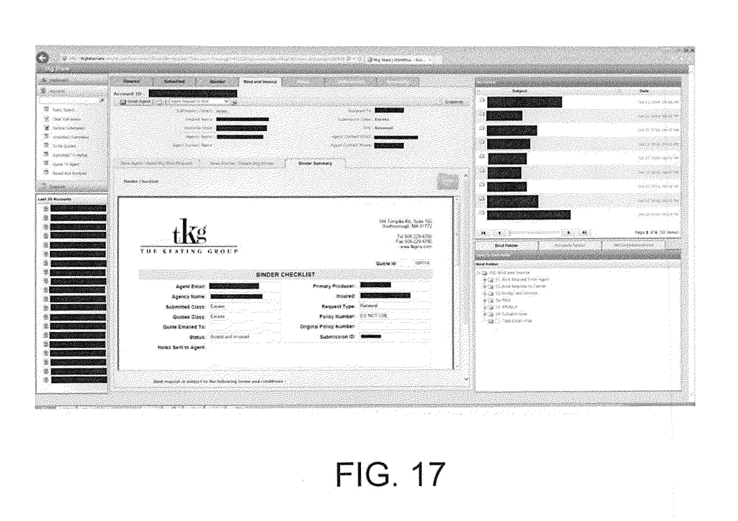

Clicking on the “Create” or “Update” folder on the “Save Carrier/Create Binder” screen will open up the binder on the left side of the screen and a data entry form on the right side of the screen, allowing binder and invoice details to be entered by the user. This is generally illustrated in FIGS. 16A and 16B.

Clicking the “Preview Invoice Binder” “Save Carrier/Create Binder” will allow the user to preview the invoice generated for the account. If the invoice is correct, the user can send the invoice to the agent. If the invoice is not correct, the user can click the “Decline” button to remove the invoice. The user can then adjust the data and invoice if needed.

After the account has been invoiced, a “Send Invoice to Agent” button will be available. Clicking the “Send Invoice to Agent” will send a template email to the agent, with the invoice attached to the email. The email is saved in the electronic document library.

After the account has been invoice the “Preview and Send Binder/Invoice to Agent” button will be available. Clicking the “Preview and Send Binder/Invoice to Agent” will send a template email to the agent along with the binder, invoice and any additional attachments to the email. The email is saved in the electronic document library.

As is also depicted in FIG. 17, a user can review the binder checklist, which contains all the necessary subjectivities needed to bind the account.

g. Policy

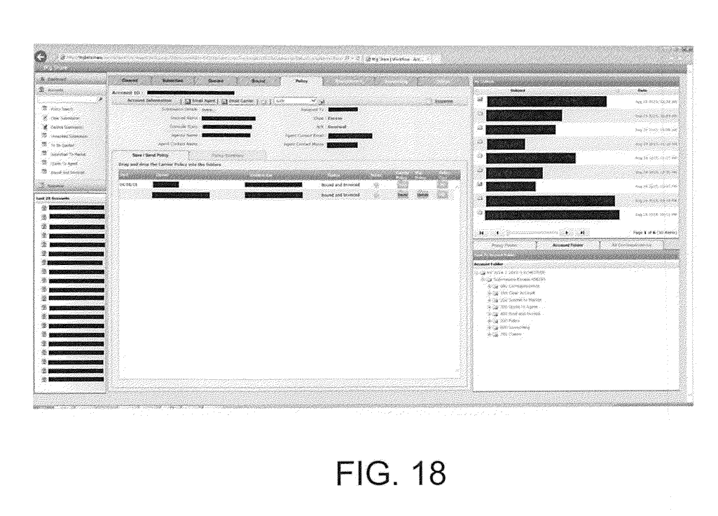

The “Policy” screen, in FIG. 18 is a basic screen to show a list of all carriers and underwriters used to bind an account. The list has a save folder, to allow the user to drag an email out of the outlook component and into a drop zone. This allows users to save the policy in the electronic document library specific to each carrier.

If a policy has been save for a specific carrier, the folder icon will turn black next to the corresponding carrier in the list of carriers, and a “Create” folder icon will appear under the “Policy” column. Once a user has sent out a policy, any new policies added to the system will cause an “Update” folder to appear under the “Policy” column.

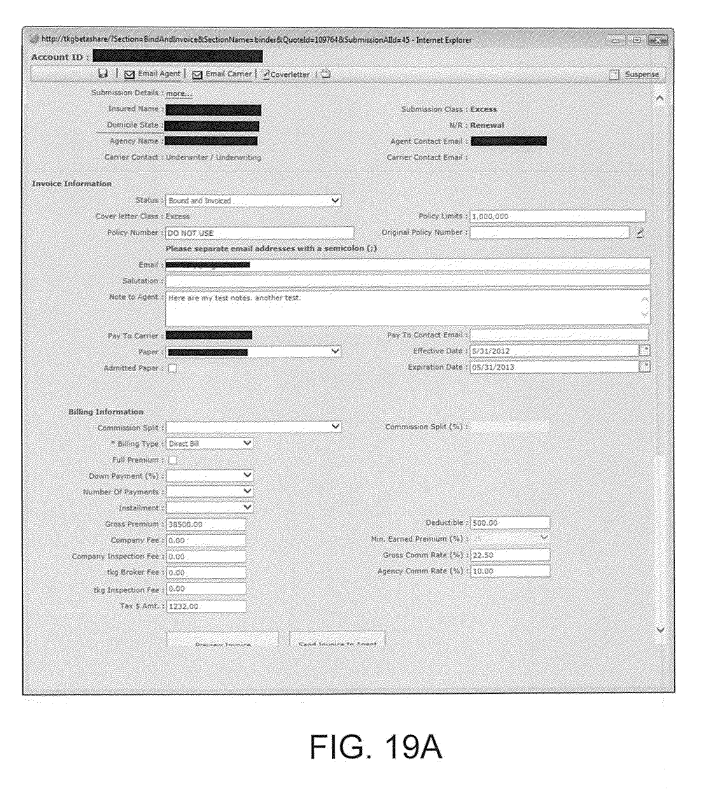

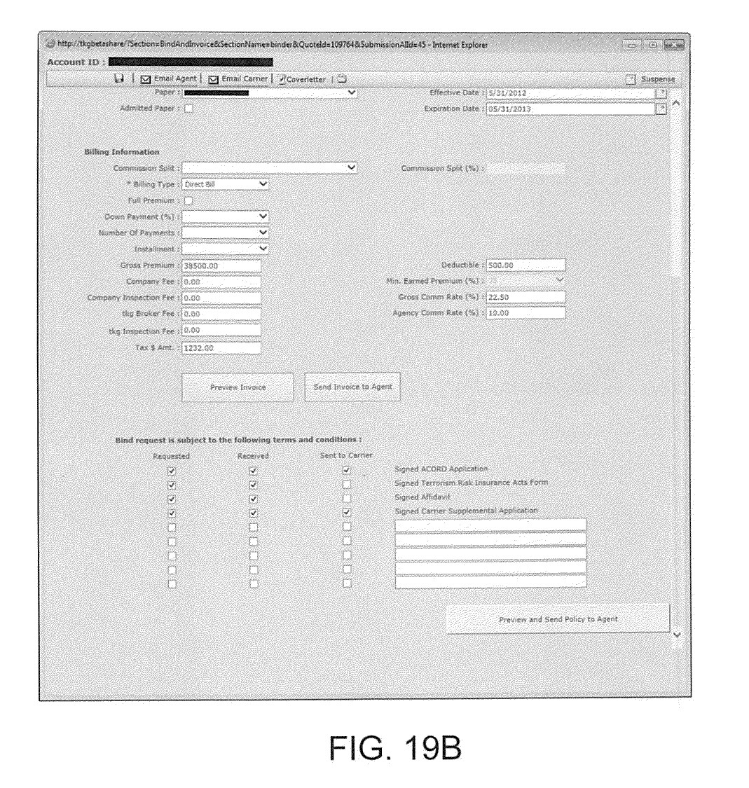

Clicking on the “Create” or “Update” folder will open up the policy on the left side of the screen, and a data entry form on the right side of the screen, where the policy details can be entered. This is generally illustrated in FIGS. 19A and 19B.

Both of the above screens have the same functionality as the bind and invoice page but instead of sending the binder to the agent it will send a template policy email to the agent. The email will be saved in the electronic document store.

h. Endorsement

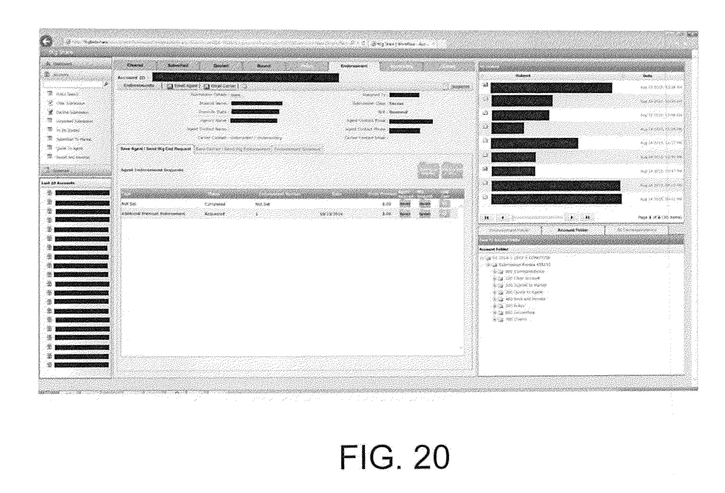

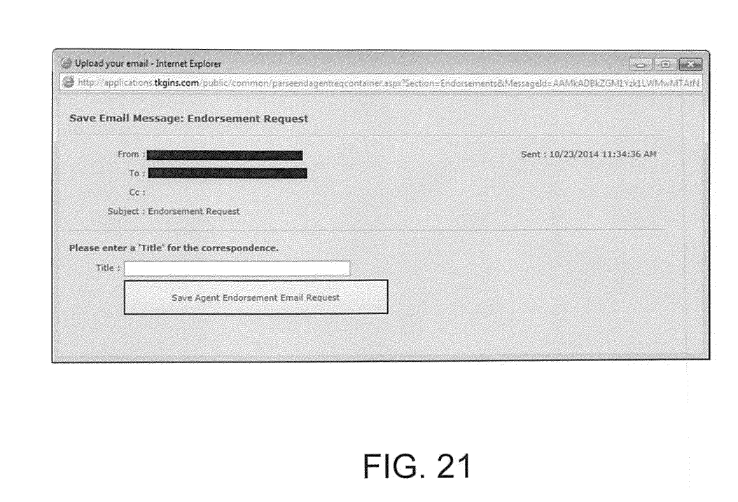

The “Endorsement” screen generally illustrated in FIG. 20 is a basic screen show a list of agent or carrier endorsement requests in the workflow management system for a specific account. A user may save and/or upload correspondence from either the agent or the carrier. In addition, users may make requests to carriers for endorsements, or send a carrier endorsement to an agent.

As shown in FIG. 20, a user can drag a request from an agent for an endorsement to the drop area, causing it to be saved and filed in the electronic document library. This allows the user to send a template endorsement request to a carrier or underwriter to start the endorsement process. This email is saved in the file. Once this has been sent, the user may then save a carrier endorsement document in the workflow management system by selecting the “Save Carrier/Send Endorsement” tab.

FIG. 21 generally illustrates the screen selected by the “Save Carrier/Send Endorsement” tab. On this screen, a user can drag in an endorsement request from an agent, and it will be saved and filed in the electronic document library. This allows users to send a template endorsement request email to a carrier or underwriter to start the endorsement process. This email is saved in the file.

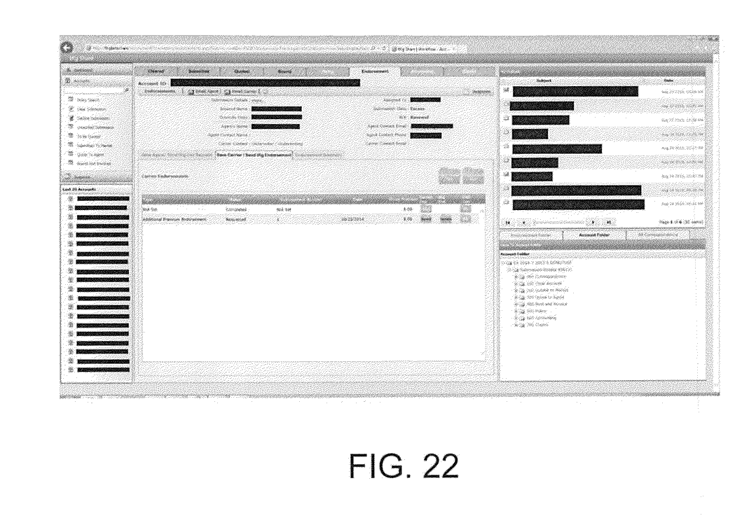

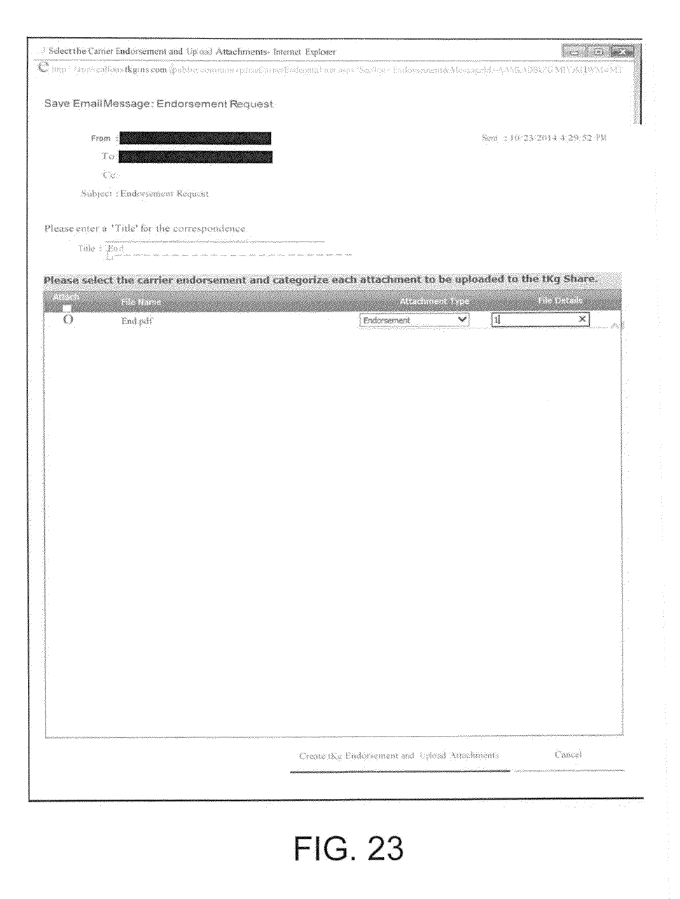

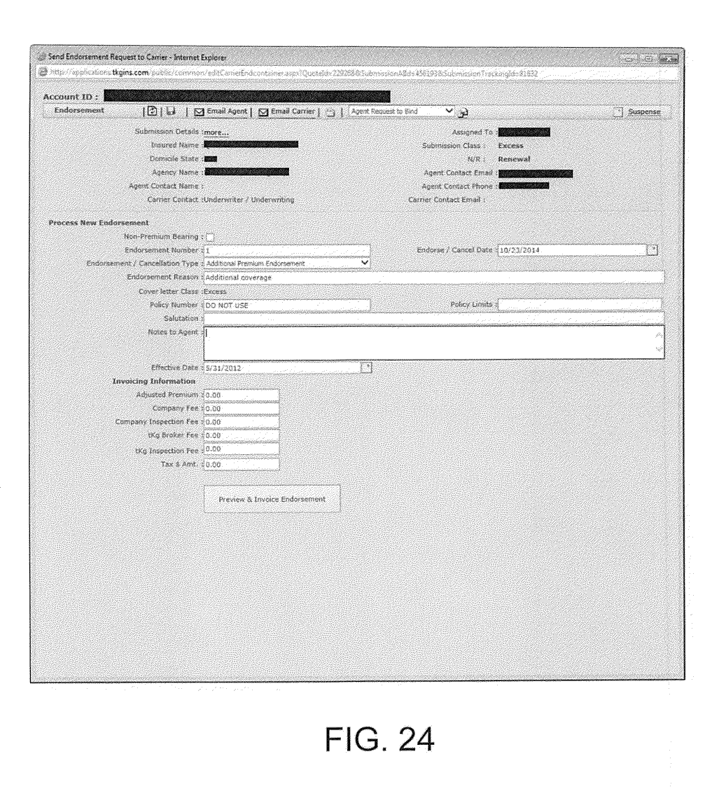

As is generally illustrated in FIG. 22, a user can drag in a request or endorsement from a carrier to be sent to an agent. If an email containing an endorsement is dragged into the file, the workflow management system will save the endorsement, and create a duplicate endorsement for a broker to redact (see FIG. 23) is generally illustrated in FIG. 24, once an endorsement has been attached, a user can send a template endorsement and invoice to an agent. This email is also saved in the file.

Clicking “Preview & Invoice Endorsement” will allow a user to send the endorsement to an agent.

i. Accounting

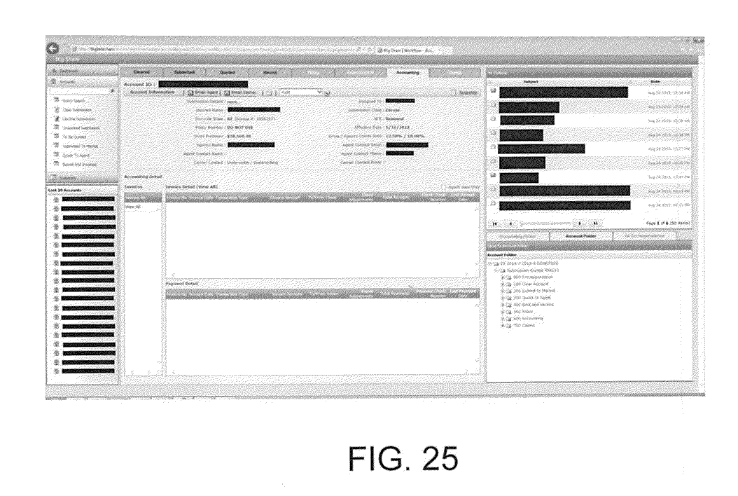

The “Accounting” screen, generally illustrated in FIG. 25, is a basic screen showing financial information on an account. From this screen, users can view and send invoices to the agent.

j. Claims

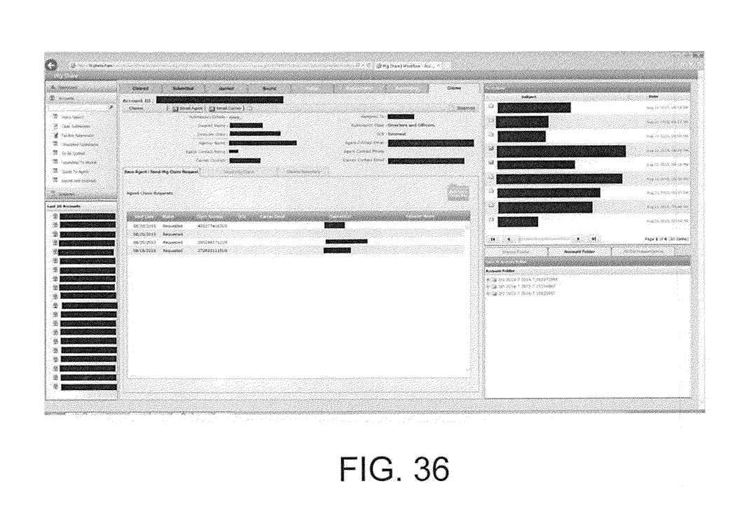

The “Claims” screen is a basic screen to show a list of agent or carrier claim requests in the system for a specific account, as shown in FIG. 36. The user can save and upload correspondence from either the agent or the carrier. In addition, they can make requests to carriers for claims or send a carrier claim adjuster to an agent.

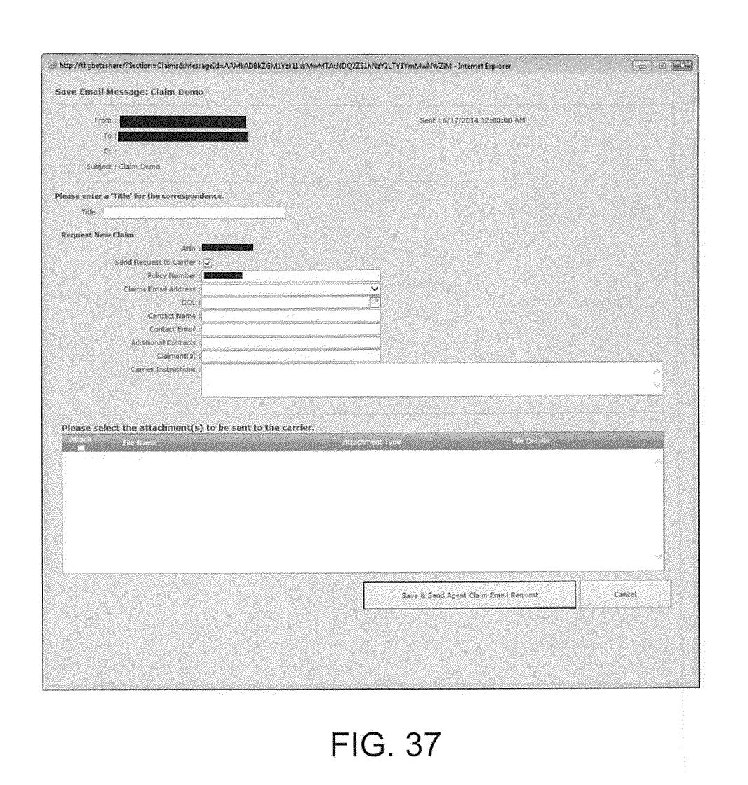

A user can drag in a request from the agent for a claim and the correspondence will be saved and filed in the electronic document store. In addition the user can enter additional details about the claim. The user can send a template claim request to the carrier or underwriter to start the claim process. This email is automatically saved in the file. Once this has been sent, the user can then be able to save the carrier claim adjuster information in the system under the “Send Claim” tab, which direct the user to a claim request screen, shown in FIG. 37.

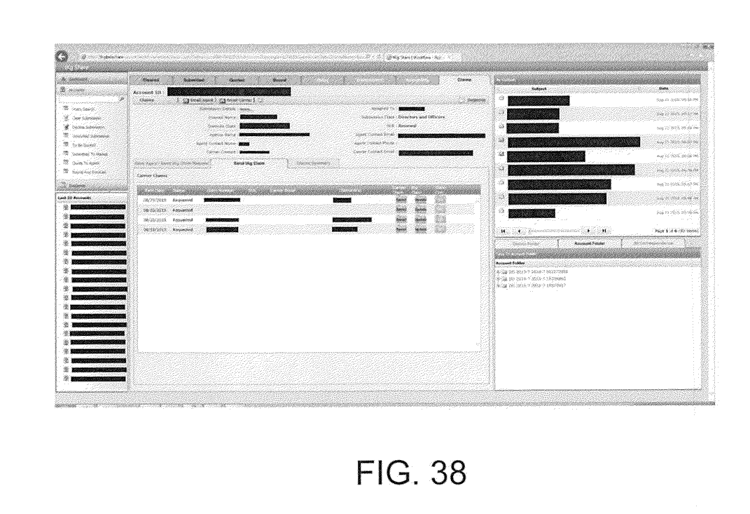

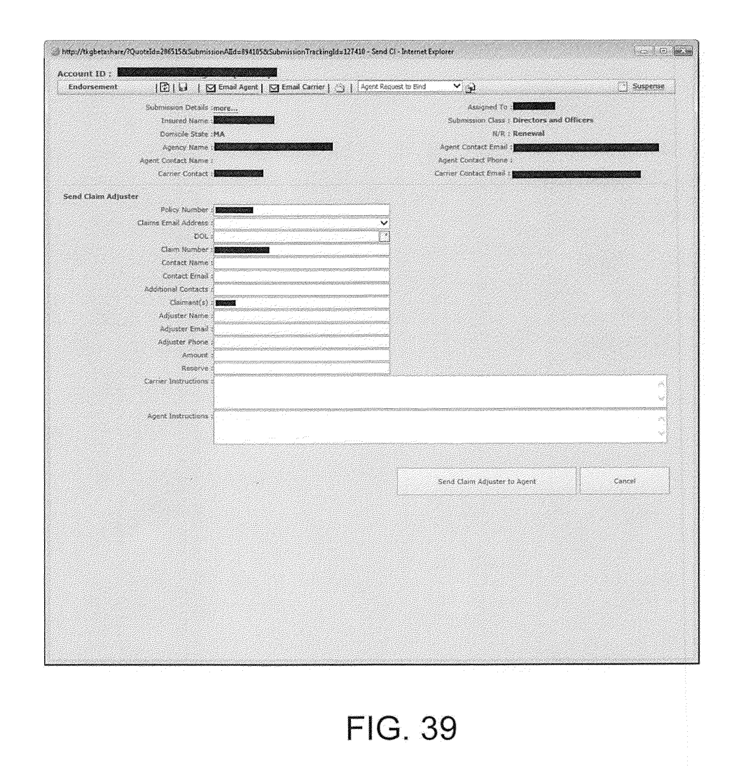

As seen Send Claim screen of FIG. 38, a user can drag in the claim adjuster information sent to the user from the carrier who is assigned to the claim. In addition, the user can send the adjusters information to the agent and the system displays the assignment screen, shown in FIG. 39.

7. Production Dashboard

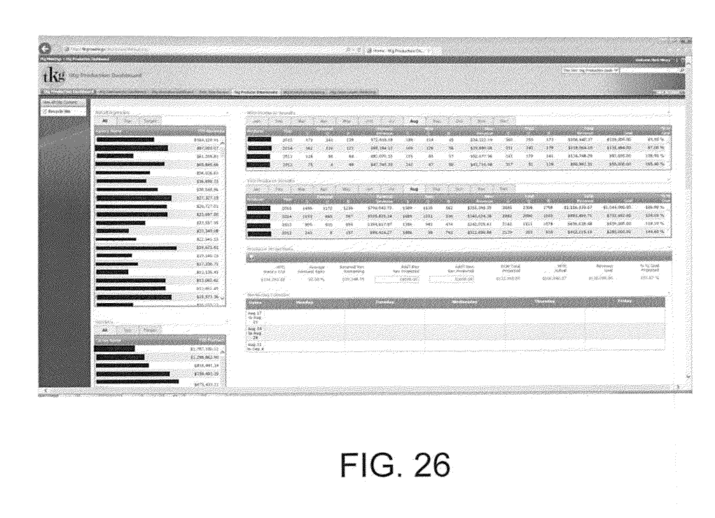

The production dashboard, shown in FIG. 26, allows a producer, team leader or the executive team the ability to manage the workflow by a company, team or individual basis. Embodiments of the present invention include three unique dashboards for each hierarchical level.

a. Producer Dashboard

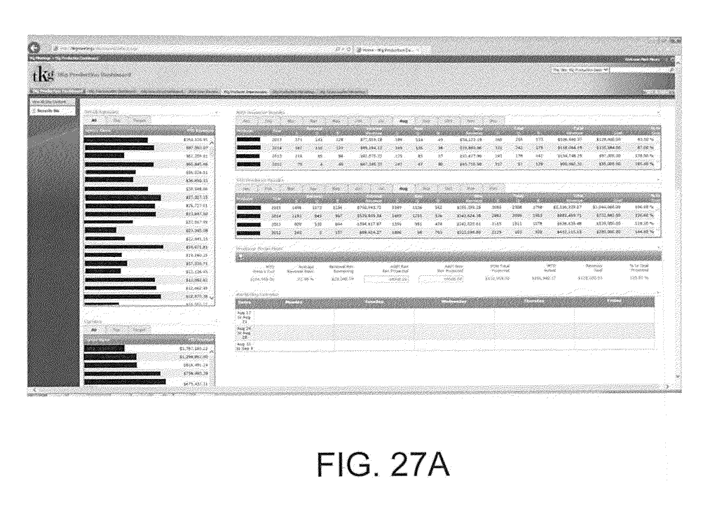

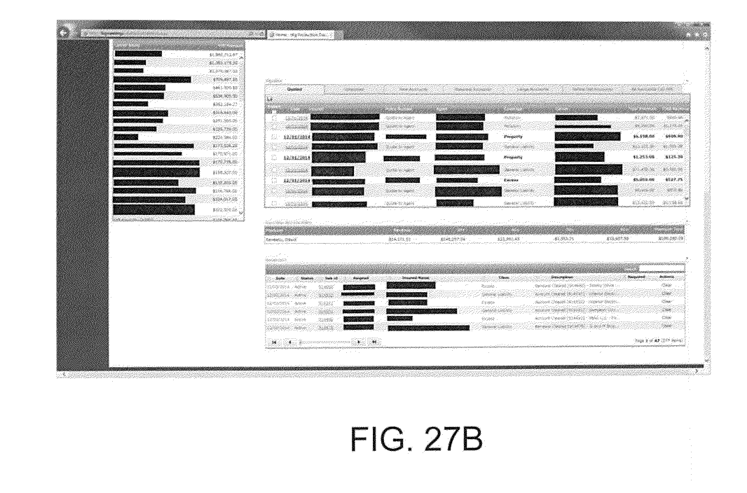

The Producer Dashboard screen, as shown in FIGS. 27A-27B is a basic screen to show a producer an overview of their accounts. The dashboard has widgets to show Retail Agencies Revenues, Carriers Premiums, MTD Results, YTD Results, producer monthly projections, Marketing calendar, Pipeline, Overdue receivables and Suspense items all in real-time. They also have the ability to drill down on each widget to get addition details

b. Team Leader Dashboard

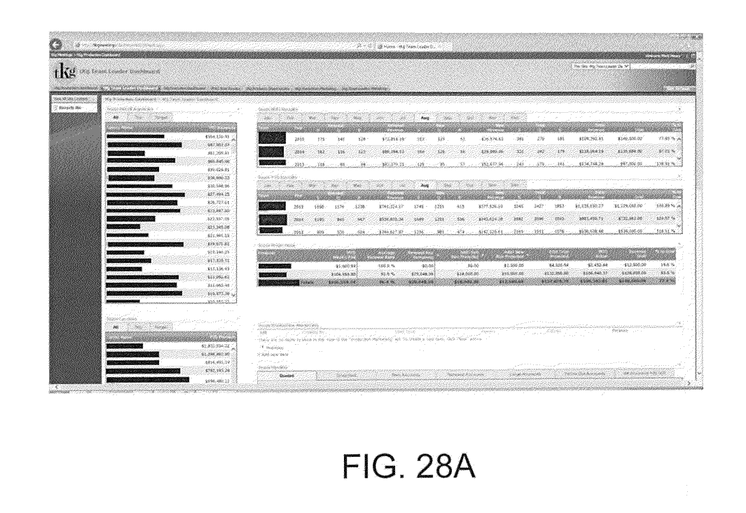

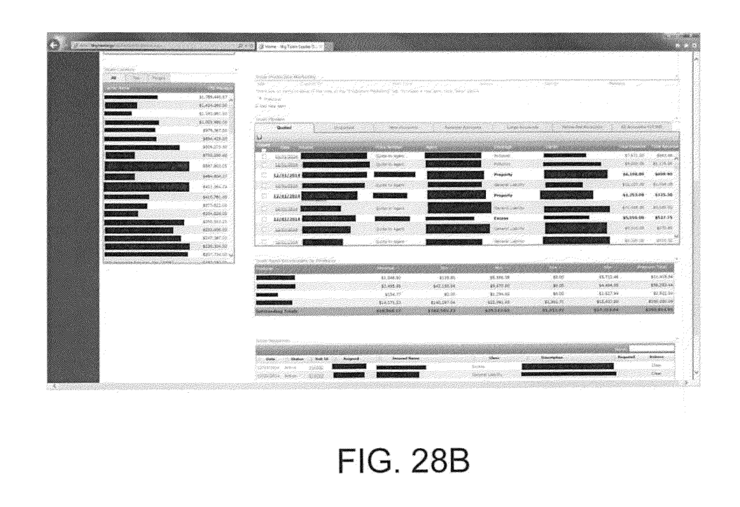

The Team Leader Dashboard screen, shown in FIGS. 28A-28B, is a basic screen to show a team leader an overview of their team accounts. The dashboard has widgets to show Retail Agencies Revenues, Carriers Premiums, MTD Results, YTD Results, producer monthly projections, Marketing calendar, Pipeline, Overdue receivables and Suspense items all in real-time. They also have the ability to drill down on each widget to get addition details

c. Executive Dashboard

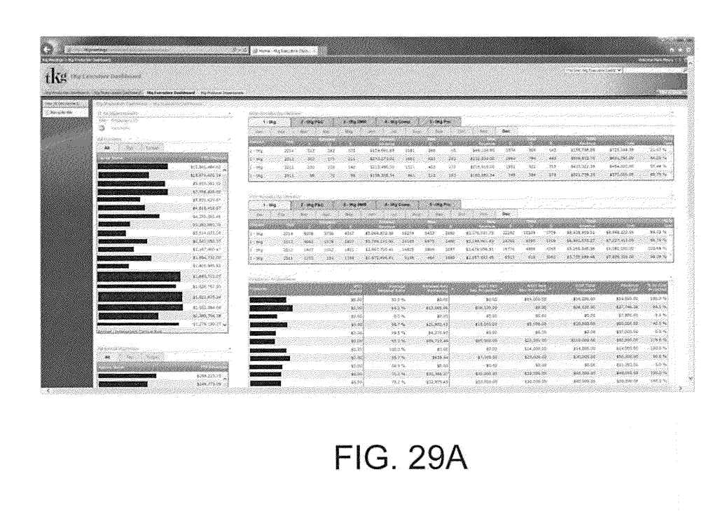

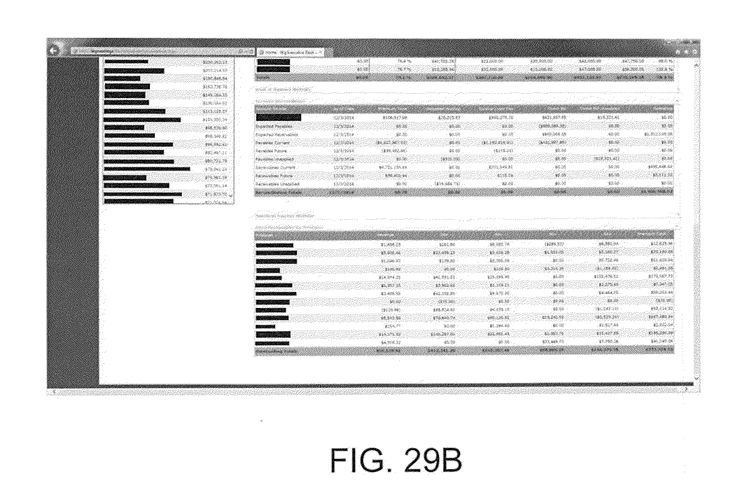

The Executive Dashboard screen, shown in FIGS. 29A-29B, is a basic screen to show an executive an overview of the division accounts. The dashboard has widgets to show Retail Agencies Revenues, Carriers Premiums, MTD Results, YTD Results, producer monthly projections, Account Reconciliation, and overdue receivables all in real-time. They also have the ability to drill down on each widget to get addition details.

It should be understood that that the folder structure of the electronic library is a critical component of the workflow management system. The server operates and executes instructions of code (software) to automatically create a folder structure within an electronic library, wherein each folder structure is associated with a particular account. The structure includes automatic naming of folders and subfolders within the folder structure. Each named folder of the workflow management system is associated with a particular aspect or transaction required to process or manage an account. The workflow management system operates to automatically save emails to the proper folder of the electronic document library. For example, in some embodiments, when a user clicks on a button to send an email, the server executes code to provide a screen on the display of the user terminal prompting the user to select the folder in which to save the email. Upon completion of typing the email and clicking on send, the server executes code to save the email into the previously selected folder. This saving of emails ensures proper documentation of all communications sent electronically through the system. This is helpful in audits, and provides other beneficial uses related to information retrieval and communication tracking.

d. Marketing Calendar

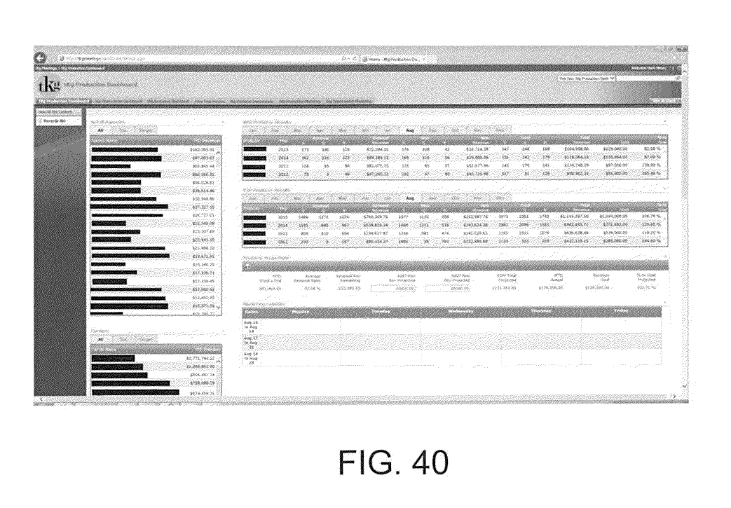

The “Marketing Calendar,” as seen in FIG. 40, displays agency visits for the current, previous and next week for a producer. The user can use the interactive marketing tools to identify marketing opportunities when the user schedules a visit with an agency.

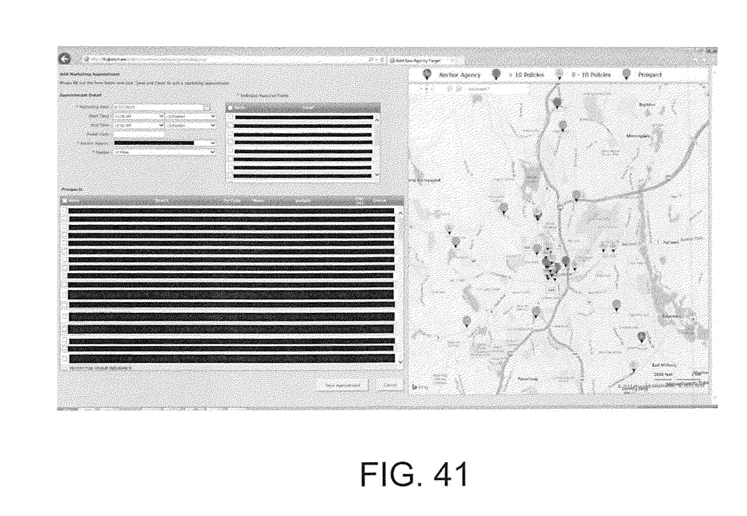

Referring to the “Add Marketing Appointment” screen in FIG. 41, a user can search for agencies in a particular area to schedule a marketing visit. This will schedule a marketing appointment on the user's marketing calendar and provide the user with an exportable calendar entry, such as but not limited to, an Outlook calendar entry, which includes navigation links to provide the user with turn by turn directions to the user's appointment.

According to embodiments, the present invention may include a method 100 of processing and managing an account during the life-cycle of the account. The method 100 may comprise providing a software application stored and operated on a computing device (Step 102), wherein the software application provides an account workflow, wherein the software application provides a user interface for each required step to process an account, the steps comprising a specific sequence of steps of clearance, followed by submit to market, followed by quote to agent, followed by bind and invoice, followed by endorsements, followed by accounting, and followed by claims. The method 100 may also include controlling a user's access to the required steps to process the account with the software application (step 104), wherein the software application controls the user's access by restricting access to and data entry through the user interface associated with a particular step until a previous step is completed. The method 100 may also include automatically creating a unique folder structure for an account (Step 106) in response to the computing device executing instructions of code of the software application to automatically create the unique folder structure within an electronic library stored on a hard drive of the computing device, wherein each folder structure is associated with the account, and the folder structure includes automatic naming of folders and subfolders within the folder structure.

The method 100 further comprises automatically saving emails sent through the system in a folder of the folder structure of the electronic library in response to executed code of the software application by the computing device.

The method 100 may further comprise providing a drag and drop feature in the software application. Operating the drag and drop feature, wherein operating the drag and drop feature operates comprises dragging an electronic file into a user interface of the software application and automatically saving the electronic file in a folder of the folder structure corresponding to the electronic file. The method 100 may also comprise automatically creating a copy of the dragged electronic file for the user to redact in response to dragging the electronic document and dropping it in an active window of the user interface.

The method 100 may further comprise automatically creating a letter in response to a user selected input, wherein the form is based on information input into the software application through the user interface. The method 100 includes automatically displaying a form screen for data entry, wherein the form screen corresponds to the letter, wherein the method further comprises automatically editing the letter in response to adding or changing the data input in the form screen.

Further still, the method 100 further comprises automatically reviewing the processing of the account for quality assurance for admitted and non-admitted policies, wherein reviewing the processing of the account comprises automatically determining by execution of the software product that certain required components of a policy submission are present.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A workflow management system comprising:
a server having a processor, memory, and a hard drive;
a user terminal in network communication with the server, wherein the user terminal is a virtual/personal computer having a processor, memory, a hard disk, a video card, a display, and input/output devices; and
a software application installed on and operated by the server, wherein the server executing the software application automatically directs a user communicating with the server with the user terminal through an insurance account binding process from clearance to invoicing, wherein:
the system comprises a unique folder structure for each account created by the server in response to the server executing instructions of code of the software application to automatically create the unique folder structure within an electronic library stored on one of the hard drive of the server or a remote data storage, wherein each folder structure is associated with a particular account, and the folder structure includes automatic naming of folders and subfolders within the folder structure.

2. The system of claim 1, wherein each named folder of the workflow management system is associated with a particular step required to process and manage an account.

3. The system of claim 1, further comprising an automatic email save function, wherein emails sent through the system are automatically saved in a folder of the folder structure of the electronic library in response to executed code of the software application by the server.

4. The system of claim 1, wherein the server performs all operations by execution of the software application and sends minimal information to the display of the user terminal in response to execution of code of the software.

5. The system of claim 1, wherein server executes code of the software application in response to user input through the user terminal.

6. The system of claim 1, wherein the software application operating on the server provides for a drag and drop feature, wherein the drag and drop feature comprises automatically saving an electronic file in a named folder corresponding to the electronic file.

7. The system of claim 6, wherein the server automatically creates a copy of the dragged electronic document for the user to redact in response to dragging the electronic document and dropping it in an active window displayed on the user terminal.

8. A workflow management system comprising:
a computing device having a processor, memory, and a hard drive; and
a software application installed on and operated by the computing device, wherein the computing device executing the software application automatically directs a user through an insurance account binding process from clearance to invoicing, wherein:
the system comprises a unique folder structure for each account created by the computing device in response to the computing device executing instructions of code of the software application to automatically create the unique folder structure within an electronic library stored on one of the hard drive of the computing device or on a remote data storage, wherein each folder structure is associated with a particular account, and the folder structure includes automatic naming of folders and subfolders within the folder structure.

9. The system of claim 8, wherein each named folder of the workflow management system is associated with a particular step required to process and manage an account.

10. The system of claim 8, further comprising an automatic email save function, wherein emails sent through the system are automatically saved in a folder of the folder structure of the electronic library in response to executed code of the software application by the computing device.

11. The system of claim 8, wherein the software application operating on the computing device provides for a drag and drop feature, wherein the drag and drop feature comprises automatically saving an electronic file in a named folder corresponding to the electronic file.

12. The system of claim 11, wherein the computing device automatically creates a copy of the dragged electronic document for the user to redact in response to dragging the electronic document and dropping it in an active window.

13. A method of processing and managing an account during the life-cycle of the account, the method comprising:
providing a software application stored and operated on a computing device, wherein the software application provides an account workflow, wherein the software application provides a user interface for each required step to process an account, the steps comprising a specific sequence of steps of clearance, followed by submit to market, followed by quote to agent, followed by bind and invoice, followed by endorsements, followed by accounting, and followed by claims;
controlling a user's access to the required steps to process the account with the software application, wherein the software application controls the user's access by restricting access to and data entry through the user interface associated with a particular step until a previous step is completed; and
automatically creating a unique folder structure for an account in response to the computing device executing instructions of code of the software application to automatically create the unique folder structure within an electronic library stored on a hard drive of the computing device, wherein each folder structure is associated with the account, and the folder structure includes automatic naming of folders and subfolders within the folder structure.

14. The method of claim 13, further comprising automatically saving emails sent through the system in a folder of the folder structure of the electronic library in response to executed code of the software application by the computing device.

15. The method of claim 13, further comprising providing a drag and drop feature in the software application.

16. The method of claim 15, further comprising operating the drag and drop feature, wherein operating the drag and drop feature operates comprises dragging an electronic file into a user interface of the software application and automatically saving the electronic file in a folder of the folder structure corresponding to the electronic file.

17. The method of claim 16, further comprising automatically creating a copy of the dragged electronic file for the user to redact in response to dragging the electronic document and dropping it in an active window of the user interface.

18. The method of claim 13, further comprising automatically creating a letter in response to a user selected input, wherein the form is based on information input into the software application through the user interface.

19. The method of claim 18, further comprising automatically displaying a form screen for data entry, wherein the form screen corresponds to the letter, wherein the method further comprises automatically editing the letter in response to adding or changing the data input in the form screen.

20. The method of claim 13, further comprising automatically reviewing the processing of the account for quality assurance for admitted and non-admitted policies, wherein reviewing the processing of the account comprises automatically determining by execution of the software product that certain required components of a policy submission are present.
